(19) United States
(12) Patent Application Publication
(10) Pub. No.: US 2004/0236035 A1
(43) Pub. Date: Nov. 25, 2004

(54) Thermoplastic, thermosetting grafted polyurethane, pure or blended, and thermoset polyurethane obtained after crosslinking

(76) Inventors: Didier Lagneaux, Chozeau (FR); Jean-Pierre Pascault, Villeurbanne (FR); Michel Dumon, Villeurbanne (FR); Francoise Mechin, Lyon (FR)

Correspondence Address: NOVEON IP HOLDINGS CORP., 9911 BRECKSVILLE ROAD, CLEVELAND, OH, 44141-3247, US

(21) Appl. No.: 10/828,114

(22) Filed: Apr. 20, 2004

Related U.S. Application Data
(63) Continuation of application No. PCT/FR02/03646, filed on Oct. 24, 2002.

(30) Foreign Application Priority Data
Oct. 26, 2001 (FR) 0113849

(51) Int. Cl. C08G 71/04

(52) U.S. Cl. 525/453

(57) ABSTRACT

Thermoplastic polyurethane, either alone or blended with other polymers, are grafted with diisocyanate trimers or blocked isocyanates. The thermoplastic polyurethane is crosslinked at a temperature above 85° C. to make the composition thermosetting. The crosslinked compositions have low compression set and are insoluble in THF.

The invention relates to a grafted thermosetting, thermoplastic polyurethane (TPU), pure or blended, which offers the advantage that it is self-crosslinking, with or without the presence of water, only in conditions of elevated temperatures (at least above 85° C., advantageously above 90° C.) and in the absence of catalyst. It also relates to the pure or blended thermoset polyurethane after self-crosslinking of said thermosetting TPU.

Various thermoplastics are used for making certain products such as pipes for conveying hot fluids, electric cables, disk center wheels, seals, silentblocs, soles of footwear, etc.

Thermoplastic polyurethanes are used in these various applications, notably for their ease of use and their exceptional properties at room temperature, their flexibility and their mechanical strength. However, these materials have the drawback of low physical resistance to heat, so that the products obtained from these materials, depending on their use, have a short service life when they are used in an environment with a relatively high temperature. On the other hand, the thermosetting polyurethane resins, though they offer effective heat resistance, are very difficult to shape, so their application is limited.

Faced with these various problems, the aim was therefore to develop polyurethanes exhibiting the physical characteristics and the ease of processing of the thermoplastic polyurethanes and the thermomechanical characteristics of the thermosetting polyurethanes, and notably their high-temperature strength.

To achieve this, it was necessary to make the TPUs crosslinkable, so that they can be processed subsequently, i.e. shaped, and only then crosslinked to obtain a thermoset finished product.

To solve this problem, the Applicant proposed, in document FR-A-2 794 759, to graft hydrolyzable organosilanes onto thermoplastic polyurethanes with the aid of a diisocyanate performing the role of bridging agent between the polymer chain and the organosilane. This bridging agent additionally makes it possible to bind the aminosilane and prevents it breaking the main chains of the polyurethane.

Even though this method can make the TPU effectively crosslinkable by polycondensation of the silanol groups, the Applicant found that the crosslinking started at room temperature and in the presence of moisture, so that long-term storage of the TPU was not possible. Furthermore, the phenomenon of crosslinking accelerates at the moment of drying (about 80° C.), so that the TPU cannot be processed. It is known, in fact, that this heating stage, before processing, is indispensable because the slightest presence of water would lead to crosslinking in the extruder during processing, resulting in serious mechanical breakage. This method has the additional shortcoming that it requires a high content and number of reagents, thus creating extra costs, and this limits the range of final applications. Finally, the Applicant found that the TPU grafted in this way could not be processed at a temperature above about 180° C. because, above that temperature, the additional crosslinking bonds created were quickly ruptured.

In other words, the objective that the invention proposes to achieve is to supply a TPU that has the following characteristics:

inability to undergo self-crosslinking in the presence of water at a temperature below at least 85° C., i.e. at a temperature at least 5° C., advantageously 10° C. above the drying temperature (about 80° C.) of the grafted TPU before processing,

smaller number of constituents,

possible processing of the grafted TPU before crosslinking at a temperature above 180° C. without destroying the bonds permitting crosslinking created in the grafted TPU.

To achieve this, the Applicant tried to graft a diisocyanate (for example MDI) directly on the TPU, in the absence of silane. The rates of the reaction of the diisocyanates with thermoplastic polyurethanes in reactors of the internal mixer or extruder type were then investigated. It was found that the reaction of grafting of one of the two functions (NCO) of the diisocyanate was very fast under pressure and at temperature, in the absence of water. The function (NCO) that remained free became less reactive. Concretely, the MVR (Melt Volume Rate) of a thermoplastic polyurethane is halved after grafting with the diisocyanate. The grafted TPU then becomes very sensitive to water, owing to the presence of the free (NCO) function. Said material, in the form of granules, cannot be stored for a long time, and cannot be manipulated easily by the final processor as it cannot be conveyed by suction and cannot be used in the open air without being dried at the last moment like all the commercial thermoplastic polyurethanes. The final drying crosslinks the polyurethane in its granulated form and does not permit its thermoplastic processing. As already mentioned, diisocyanate grafted polyurethane should not, in particular, be processed without drying it, because the slightest presence of water would lead to crosslinking, which would cause serious mechanical breakage during processing.

The grafted TPU proposed by the invention solves all of these problems.

More precisely, the invention relates to a grafted thermosetting, thermoplastic polyurethane, pure or blended, that can be obtained by direct grafting onto a thermoplastic polyurethane, pure or blended, of a crosslinking agent selected from the group comprising the diisocyanate trimers that are able to initiate the crosslinking reaction at a temperature above 85° C. and blocked isocyanates, solid or liquid, whose unblocking point is above 85° C.

In the rest of the description and in the claims, “pure or blended TPU” means a TPU on its own or blended with at least one thermoplastic polymer selected from the group comprising, non-limitatively, PP (polypropylene), PET (polyethylene terephthalate), POM (polyoxymethylene), PBT (polybutylene terephthalate), HDPE (high-density polyethylene), PS (polystyrene: atactic, isotactic and syndiotactic), ABS (acrylonitrile/butadiene/styrene), PMMA (polymethyl methacrylate), PC (polycarbonate), PVC (polyvinyl chloride), PEEK (polyether ether ketone), PPE (polyphenylene ether), PSU (polysulfone), aliphatic polyketone, their homo-, co- and terpolymers. PE (polyethylene), PP (polypropylene) metallocene, SBS (styrene butadiene styrene), SEBS (styrene ethylene butadiene styrene), COPE (copolyester block ester), EPDM (ethylene propylene diene), their homo-, co- and terpolymers.

The ratio of TPU to thermoplastic polymer will, of course, vary depending on the desired mechanical characteristics of the final blend, in practice between 100/00 and 40/60 and advantageously 70/30.

Such a thermosetting polyurethane is novel relative to the state of the art known to the Applicant, not only with respect to its structure (limited number of constituents and specific crosslinking agent), but also with respect to its behavior. The Applicant in fact found, quite surprisingly, that selection of the crosslinking agent, in the absence of silane, avoided triggering a phenomenon of crosslinking at room temperature despite the presence of water and that it was necessary, to initiate crosslinking, to increase the temperature to the region of at least 85° C., i.e. to a temperature above the drying temperature (80° C.), and in the absence of catalyst. In practice, crosslinking is effected at a temperature above 100° C., between 110 and 130° C. or more, depending on the unblocking temperature of the diisocyanate, for 2 hours, after an initial absorption of moisture of the polymer for 24 hours. It is possible to crosslink the thermosetting TPU of the invention at room temperature, but only in the presence of a catalyst of the tin or bismuth type and for several days. In other words, the grafted thermoplastic polyurethane of the invention reacts very little, if at all, with water at temperatures below 85° C., advantageously 100° C., which means it can be stored in the open air in standard polyethylene bags. Moreover, this makes it possible for the final processor to handle the grafted product without special precautions, only observing the usual precautions for standard thermoplastic polyurethanes. As already stated, it is thus possible, before crosslinking, to dry the polyurethane for at least 2 hours, advantageously 6 hours, without the grafted TPU beginning to crosslink. Moreover, the Applicant found that the viscosity of the thermoplastic polyurethane, after grafting, was only reduced by a factor of 1.5 instead of 2 when the polyurethane is grafted with a diisocyanate, making it possible to widen the working range. Furthermore, during final processing, the MVR of the material decreases further by a factor of 2, which improves the rheology of the polymer in the extruder and the gauging equipment, and reduces the formation of cold shots during injection into the molds. Finally, it appears that the behavior of the grafted polyurethane is closer to that of the polyethylenes than the standard thermoplastic polyurethanes. In conclusion, the Applicant observed that the crosslinks had much higher temperature resistance than those obtained with the diisocyanates, used alone or in the presence of silanes. This makes it possible, in the case of the blend of TPU with other polymers, to avoid breaking the crosslinks, and therefore avoid losing the mechanical, thermal and chemical characteristics of the blend during final processing, at elevated temperatures above 180° C.

According to a first characteristic of the invention, the crosslinking agent is a trimer of diisocyanate or a blocked isocyanate, whose basic molecules are each selected from the group comprising IPDI (5-isocyanato-1-(isocyanatomethyl)-1,3,3-trimethylcycloexane), HDI (1,6-diisocyanatoexane), TDI (1-3 diisocyanatomethylbenzene), 2,4′-MDI (1 isocyanato-2(4-isocyanatophenyl) methylbenzene), 4,4′ MDI (1,1-methylene bis (4-isocyanatobenzene)), 2,4-TDI (2,4 diisocyanato-1-methylbenzene) and PPDI (1,4-diisocyanatobenzene), H₁₂ MDI (1,1-methylene bis (4-isocyanatocyclohexane)), CHDI (trans-1,4-diisocyanatocyclohexane), TMDI (1,6-diisocyanato-2,2,4 (or 2,4,4)-trimethylhexane), m-TMXDI (1,3-bis (1-isocyanato-1-methylethylbenzene), p-TMXDI (1,4-bis (1-isocyanato-1-methylethylbenzene, NDI (1,5-diisocyanatonaphthalene), polymeric MDI (isocyanic acid, polymethylene polyphenylene ester), Desmodur R (1,1′, 1″-methyllidynetris (4-isocyanatobenzene)), Desmodur RI (4-isocyanatophenol phosphorothioate (3:1) ester).

In the case of the blocked isocyanates, which can be dimers, trimers etc., the blocking molecule is any molecule usually used (caprolactam, oxime etc.) and perfectly familiar to a person skilled in the art, in particular the molecules described in the works: W. Wicks Prog. Org. Coat. 9, p3, 1981 and L.TLPhai et al. Makromol. Chem. 186, 1189, 1984.

According to another characteristic, the crosslinking agent represents between 0.5 and 20 wt. % of the grafted polyurethane, alone or blended.

In a preferred embodiment, the crosslinking agent is a trimer of IPDI and represents between 1 and 6 wt. % of the grafted polyurethane, alone or blended.

In practice, the grafted TPU of the invention is in the form of granules which can be stored as they are and processed subsequently by the processor directly by extrusion, calendering, injection, etc., and as already mentioned at elevated temperatures above 180° C. owing to the choice of crosslinking agent.

In another embodiment, the TPU is grafted then processed directly, continuously so as to obtain profiles of a given shape.

The invention also relates to the method of manufacture of the grafted polyurethane described above, which consists of reacting, at a temperature of at least 85° C., a pure or blended thermoplastic polyurethane, with one of the crosslinking agents described above, advantageously a trimer of IPDI, and then recovering the grafted, thermosetting, thermoplastic polyurethane obtained.

By selecting the aforementioned crosslinking agents, on account of their structure, it is possible to slow down the grafting reaction and in fact prevent complete crosslinking of the TPU during manufacture of the grafted polymer at a temperature above 85° C.

The invention also relates to the thermoset polyurethane that can be obtained after self-crosslinking of the grafted, thermosetting, thermoplastic polyurethane described above.

The invention and the advantages resulting from it will become clearer from the following examples of application.

### EXAMPLE 1

Materials:

Polyurethane from Estane 58447 ester

NOVEON:

type,

Shore A Hardness 90,

Kofler melting point

approx. 185° C.

IPDI trimer from Vestanat T1890/100

DEGUSSA:

58447 control material: viscosity measured on melt indexer at 210° C. under 8.16 kg=40.

Material 58447+4 p.h.r. of Vestanat T1890/100 extruded at 185° C. on a single-screw extruder diameter 40 L 40 at 56 rev/min: viscosity measured on melt indexer at 210° C. under 8.16 kg=30.

Material 58447+4 p.h.r. of Vestanat T1890/100 extruded at 185° C. on a single-screw extruder diameter 40 L 40 at 56 rev/min, then re-extruded at 200° C. on the same extruder: viscosity measured on melt indexer at 210° C. under 8.16 kg=15.

Material 58447+4 p.h.r. of Vestanat T1890/100 extruded twice, then put under a heating press at 200° C. for 10 minutes under 11 tonnes of pressure to obtain a test specimen of 100 mm×100 mm×2 mm:

the viscosity of the material of which the test specimen is constituted can no longer be measured by the melt indexer,

the material no longer dissolves in THF,

the Kofler melting point ranges from 185° C. for the control to 240° C. for the material of the test specimen,

the value for compression set at 70° C. for 24 hours ranges from 65% for the control to 25% for the test specimen.

### EXAMPLE 2

Materials:

Polyurethane from Estane 58315 ether

NOVEON:

type,

Shore A Hardness 85,

Kofler melting point

approx. 150° C.

IPDI trimer from Vestanat T1890/100

DEGUSSA

58315 was blended with 4 p.h.r. of Vestanat in a single-screw extruder of the same type as in example 1, to obtain granules of grafted 58315. After storage for one month, the grafted granules were dried in a ventilated stove at 80° C. for 2 hours, then processed on a calender at 190° C. to obtain a sheet 1 mm thick. The same calendering operation was carried out with the control 58315.

Test specimens were cut from each of the two sheets, for carrying out a hot set test as used by the cable manufacturer. The material is subjected to a stress of 0.2 MPa in a stove at 200° C. The control specimen broke inside two minutes. The crosslinked test specimen exceeded the limit of 15 minutes.

### EXAMPLE 3

Materials:

Polyurethane from Estane 58277 ester

NOVEON:

type,

Shore A hardness 95,

Kofler melting point

approx. 150° C.

SBS from ASAHI:

Tufprene A,

Shore A hardness 88,

Melting point 120° C.

MDI from BAYER: Desmodur 44 M

IPDI trimer from Vestanat T1890/100

DEGUSSA:

Blends were effected 3 times on an extruder identical to the preceding examples. Then test specimens with thickness of 2 mm were made in a press heated at 200° C. for 11 minutes.

| | | | | |
|---|---|---|---|---|
| 58277: | | 70% | Kofler | compounding 1: 150° C. |
| | {close oversize brace} | | melting | compounding 2: 150° C. |
| Tufprene: A | | 30% | point | compounding 3: 150° C. |
| 58277: | | 70% | Kofler | compounding 1: 220° C. |
| Tufprene: A | {close oversize brace} | 30% | melting | compounding 2: 220° C. |
| IPDI: trimer | | 3 p.h.r. | point | compounding 3: 220° C. |
| 58277 | | 70% | Kofler | compounding 1: 200° C. |
| Tufprene: A | {close oversize brace} | 30% | melting | compounding 2: 180° C. |
| MDI: | | 3 p.h.r. | point | compounding 3: 160° C. |

1. Grafted thermosetting, thermoplastic polyurethane, pure or blended, that can be obtained by direct grafting, onto a pure or blended thermoplastic polyurethane, of a crosslinking agent selected from the group comprising diisocyanate trimers that are able to initiate the crosslinking reaction at a temperature above 85° C. and the blocked isocyanates, solid or liquid, whose unblocking point is above 85° C.

2. Polyurethane as claimed in claim 1, characterized in that the crosslinking agent is a diisocyanate trimer or a blocked isocyanate, whose basic molecules are each selected from the group comprising IPDI (5-isocyanato-1-(isocyanatomethyl)-1,3,3-trimethylcycloexane), HDI (1,6-diisocyanato-exane), TDI (1-3 diisocyanatomethylbenzene), 2,4′-MDI (1 isocyanato-2(4-isocyanatophenyl) methylbenzene), 4,4′ MDI (1,1-methylene bis (4-isocyanatobenzene)), 2,4-TDI (2,4 diisocyanato-1-methylbenzene) and PPDI (1,4-diisocyanatobenzene), H₁₂ MDI (1,1-methylene bis (4-isocyanatocyclohexane)), CHDI (trans-1,4-diisocyanatocyclohexane), TMDI (1,6-diisocyanato-2,2,4 (or 2,4,4)-trimethylhexane), m-TMXDI (1,3-bis (1-isocyanato-1-methylethylbenzene), p-TMXDI (1,4-bis (1-isocyanato-1-methylethylbenzene, NDI (1,5-diisocyanatonaphthalene), polymeric MDI (isocyanic acid, polymethylene polyphenylene ester), Desmodur R (1,1′,1″-methyllidynetris (4-isocyanatobenzene)), Desmodur R1 (4-isocyanatophenol phosphorothioate (3:1) ester).

3. Polyurethane as claimed in one of the preceding claims, characterized in that the crosslinking agent represents between 0.5 and 20 wt. % of grafted polyurethane, alone or blended.

4. Polyurethane as claimed in claim 2, characterized in that the crosslinking agent is a trimer of IPDI and represents between 1 and 6 wt. % of the grafted polyurethane, alone or blended.

5. Polyurethane as claimed in claim 1, characterized in that the TPU is a blend with a thermoplastic polymer selected from the group comprising, non-limitatively, PP (polypropylene), PET (polyethylene terephthalate), POM (polyoxymethylene), PBT (polybutylene terephthalate), HDPE (high-density polyethylene), PS (polystyrene: atactic, isotactic and syndiotactic), ABS (acrylonitrile/butadiene/styrene), PMMA (polymethyl methacrylate), PC (polycarbonate), PVC (polyvinyl chloride), PEEK (polyether ether ketone), PPE (polyphenylene ether), PSU (polysulfone), aliphatic polyketone, their homo-, co- and terpolymers. PE (polyethylene), PP (polypropylene) metallocene, SBS (styrene butadiene styrene), SEBS (styrene ethylene butadiene styrene), COPE (copolyester block ester), EPDM (ethylene propylene diene), their homo-, co- and terpolymers.

6. Polyurethane as claimed in one of the preceding claims, characterized in that it is in the form of granules.

7. Method of manufacture of the grafted polyurethane as claimed in one of the claims 1 to 6, characterized in that it consists of reacting, at a temperature of at least 85° C., the pure or blended TPU with the crosslinking agent and then recovering the grafted, thermosetting, thermoplastic polyurethane obtained.

8. Thermoset polyurethane that can be obtained after self-crosslinking of the polyurethane as claimed in one of the claims 1 to 6.
